(19) United States
(12) Patent Application Publication
(10) Pub. No.: US 2016/0290964 A1
(43) Pub. Date: Oct. 6, 2016

(54) PIPELINE TRANSMITTER AND METHOD FOR FABRICATION

(71) Applicant: Vikraman Raghavan, Houston, TX (US)

(72) Inventor: Vikraman Raghavan, Houston, TX (US)

(21) Appl. No.: 15/087,621

(22) Filed: Mar. 31, 2016

Related U.S. Application Data
(60) Provisional application No. 62/140,967, filed on Mar. 31, 2015.

(51) Int. Cl. G01N 27/82

(52) U.S. Cl. CPC G01N 27/82

(57) ABSTRACT

The transmitter of this application provides a tubular body fabricated from an aluminum tube into which is inserted an electrical coil formed from high permeability nickel alloy material which is rolled into coiled sheets then inserted one into the second and sometimes third sheet. A battery is inserted into the nickel alloy tubing formed from these coiled sheets and connected to the electrical coil. Electronics comprising a constant output voltage switching power regulator, a Hall effect sensor, a micro-processor and a MOSFET bridge energize the coil in alternating directions providing a magnetic field capable of detection by the transmitter signal detectors used in the pipeline business. The duty cycle and frequency can also be adjusted through an exterior magnetic force pulse generator to communicate with the microprocessor within the transmitter.

The present application is for a pipeline transmitter for use in a pipeline Pig; more specifically, the present application discloses a pipeline transmitter installed within a conductive outer protective cover, and an induction coil around a high-permeability nickel alloy core into which is inserted the battery pack and electronics providing an enhanced magnetic field signal over a extended period of time detectable by standard Pig receivers.

### BACKGROUND OF THE INVENTION

It has been well known that transmitters can be installed in a Pipeline Pig—including but not limited to Foam Pigs, Inspection Pigs, and Mandrel Pigs. These transmitters are used to perform a number of useful functions, including but not limited to:
confirming Pig passage at a given location on the pipeline (with a compatible receiver);
benchmarking time of Pig passage at a location on the pipeline (with a compatible receiver); and
acting as a beacon for search & rescue of a stuck Pig (with a compatible receiver).

These functions are well known in the industry and have long been undertaken for these purposes. What has been lacking in this industry is a low-cost, efficient Pig transmitter. Because of the use of some Pigs in highly corrosive pipeline situations, often using a disposable Pig transmitter is most efficient and desirable way to run a survey of a pipeline. The pipeline transmitter disclosed herein generates a high strength magnetic Radio Frequency signal in the ELF band, specifically between 12 Hz and 30 Hz for low frequency detectors and can be fabricated in either a disposable model or a reusable model without significant cost.

### SUMMARY OF INVENTION

A pipeline transmitter comprising a conductive outer protective tubular body; an insulated interior tubular body formed from layered annealed nickel alloy sheets rolled into a circular tube; a coil of conductive wiring wound around the interior tubular body providing an electrical connection to an electrical circuit comprised of a battery system inserted within the interior tubular body, and a electrical connection for energizing the circuit with an alternating current from the batteries. The interior tubular body of the pipeline transmitter is formed from at least two rolled sheets of an annealed high-permeability nickel alloy, one of which is inserted, without lamination, concentrically in the other or others to form the interior tubular body. The pipeline transmitter is hermetically sealed either by filing the interior of the outer protective body with an epoxy, which is then allowed to cure to engage an enclosing end cap. This form of pipeline transmitter can therefore be discarded after its use. The pipeline transmitter can also be hermetically sealed by one or more O-rings between a threaded cap connected to the outer protective tubular body and a threaded upper end of the interior tubular body and refurbished after each use.

The battery system which powers the coil and electronics is made of multiple cells connected to provide an output potential for an extended life. The battery system can be connected in parallel or serially. The electrical circuit creates on an on-off square wave signal to energize the coils to generate a magnetic moment from each side of the magnetic coil.

The pipeline transmitter may also comprise a sealed tubular conductive body; an electrically conductive coil helically wound around a tubular body fabricated from an annealed nickel alloy providing a high magnetic permeability; a battery power supply inserted in the annealed nickel alloy tubular body; and, a circuit connected between the battery power supply and the electrically conductive coil providing switched polarity current to the electrically conductive coil. The sealed tubular conductive body can be fabricated from aluminum or other conductive material.

The pipeline transmitter has an inner tubular body, formed from at least two annealed nickel alloy, consisting essentially of 77% nickel, 16% iron, 5% copper, and 2% chromium. Alternatively, the pipeline transmitter can be fabricated using sheets of annealed nickel alloy that consists essentially of 79% nickel, 16% iron, and 5% molybdenum or an annealed nickel alloy of 65% nickel, 31% iron, and 4% germanium.

### BRIEF DESCRIPTION OF THE DRAWINGS

FIG. 1 is a schematic block diagram of the transmitter electronic circuit.

FIG. 2 is a cross-sectional view of a disposable model of transmitter.

FIG. 3 is a cross-sectional view of a reusable model of transmitter.

FIG. 4 is a cross-sectional view of the 8.25 inch transmitter coil, showing four layers of windings about the tubular core.

FIG. 5 is a cross-sectional view of the 5 inch transmitter coil, showing six layers of windings about the tubular core.

### DETAILED DESCRIPTION OF EMBODIMENTS OF THE INVENTION

### Models & Sizes

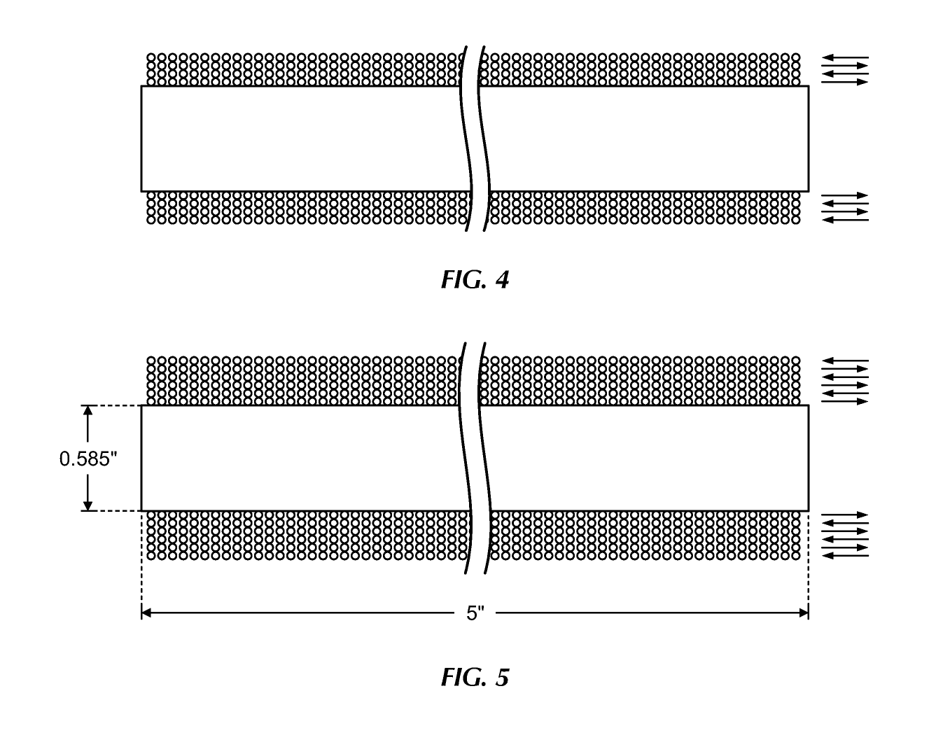

The present embodiments of the invention of this application are currently constructed in three differing sizes and forms: three disposable transmitters ranging from 1.875″ diameter by 9.5″ in length; 1.25″ diameter by 6″ in length; and 1″ diameter by 3″ in length, each designed to fit within standard pipeline surveying equipment found on the market. Applicants also provide two reusable transmitter sizes: a transmitter with 4 replaceable “C” batteries 1.875″ diameter by 9.5″ in length; and a smaller transmitter with 2 replaceable “AA” batteries 1.125″ diameter by 6″ in length. FIGS. 4-5 disclose the number of layers of coiled magnet wire of varying sizes. Other sizes can be fabricated to conform to different Pig sizes. For example, the transmitter shown in FIG. 5 can be shortened by half the length, however a shorter coil will lower the signal strength irrespective of the power supply.

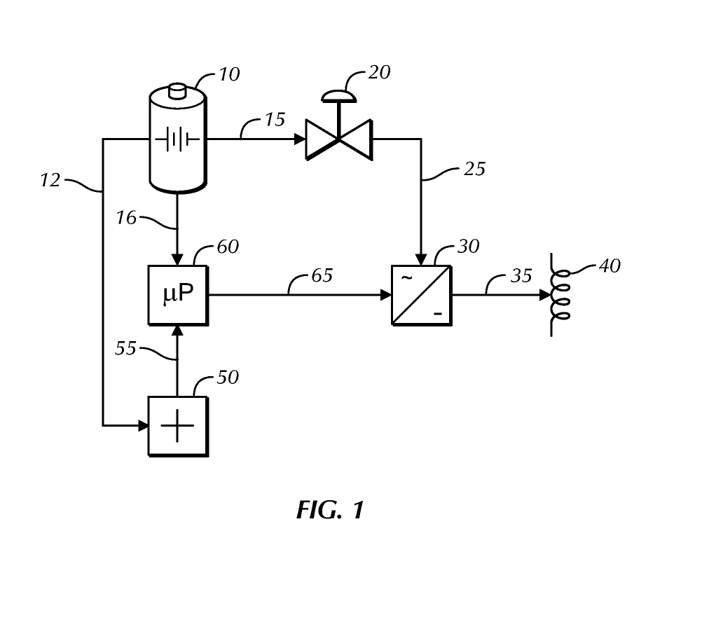

As shown in FIG. 1, each Coil 40 is powered by constant output voltage, switching power regulator 20 which provides through connection 25 a constant output signal strength through at least 90% of the life of the disposable transmitter or 85% of the life of the battery in reusable transmitter with replaceable batteries 10. As shown, a MOSFET bridge (H-bridge) 30 acts as an inverter producing a square-wave voltage waveform through connection 35 across the Coil 40. The battery 10 in each embodiment delivers no more than 0.5 Watts to the constant output voltage, switching power regulator 20, which delivers approximately the same power through connection 25 to the MOSFET bridge.

Battery 10 also powers through the conductor path 16 both the microprocessor 60 and through the conductor path 12 the Hall-Effect Sensor 50, which also acts as a switch both before installation through contact with a magnet found in the storage container holding the transmitter in an OFF state, and after installation when the Hall-Effect Sensor 50 is used to energize the MOSFET bridge 30 to invert the current flowing through the Coil 40.

Hall Effect sensor 50 used in the Transmitter can be a Unipolar Hall-Effect switch. The Hall Effect switch is Turned “ON” in the presence of either a North Pole or South Pole magnetic field with strength greater than +42 Gauss (South pole) or less than −48 Gauss (North Pole). Absence of magnetic field or presence of magnetic field between −48 Gauss and 42 Gauss causes the switch to turn “OFF.” The magnetic strength required to trigger the Hall effect switch 50 is far greater than the field created by the transmitter Coil 40 under full power. The output of the Hall sensor 50 is connected to the Micro-Processor 60. The Transmitter uses its integrated Hall-effect sensor for two functions: 1. To change the operating parameters of the Transmitter including but not limited to frequency and duty-cycle. 2. To turn OFF the Transmitter. The Hall effect sensor's output 55 is connected to the Micro-processor's 60 serial port. Sending a train of coded pulses with an external electromagnet will cause the micro-processor 60 to execute instruction to change the operational parameters, thus allowing operation of the Transmitter to be adapted to varying conditions without disassembly of the Transmitter body.

The Hall-Effect Sensor 50 thus acts as a soft-switch (as previously noted) in disposable transmitters and optionally can be used to configure transmitter operational parameters such as frequency and duty-cycle through communication in connector 55 with the Micro-Processor 60.

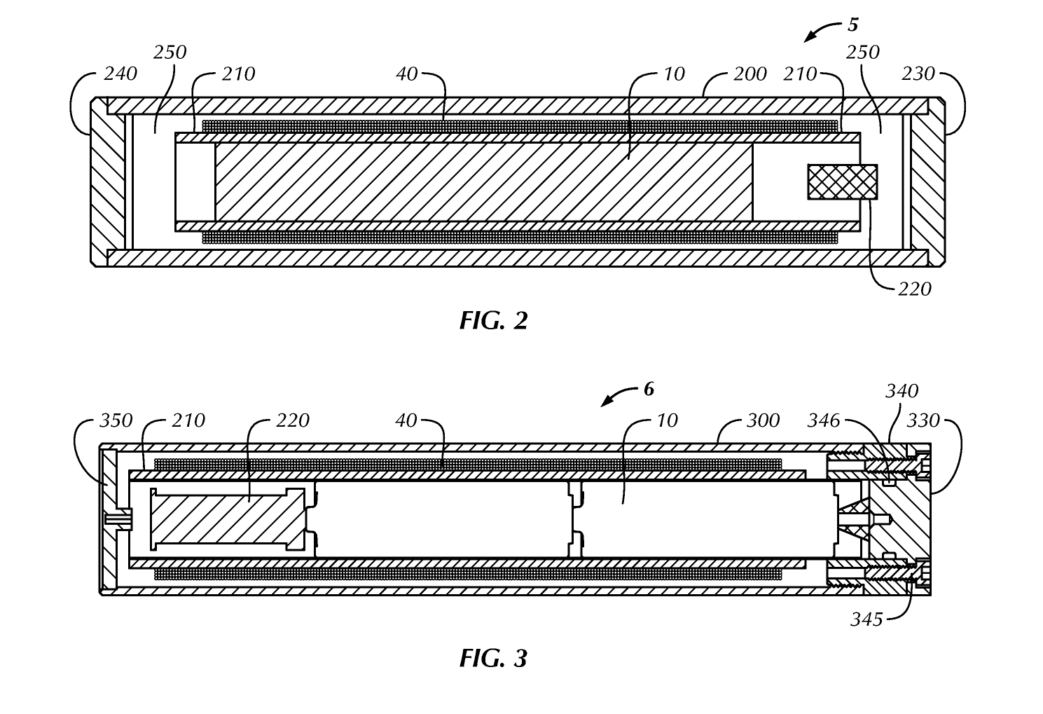

FIG. 2 shows the disposable form of the Transmitter 5 of the present application. An external aluminum housing 200 provides a tubular cavity allowing a nickel alloy core 210 to support the coil 40. The interior of the nickel alloy core 210 holds the battery 10 and the electronics 220 previously described in FIG. 1. After insertion of the Coil 40 energized with a fresh battery 10 at the Applicant's plant, the assembly is placed in the external aluminum housing 200 which is then filled with epoxy 250, and two aluminum end caps 230 and 240 seal the Transmitter in the external aluminum housing 200.

The nickel alloy core 210 is fabricated from a series of at least two high permeability nickel and iron alloy sheets rolled into tubes and inserted into the other to form a coaxial tube around which the magnet wire is wound. The high permeability metal used can be Mu-metal which consists of 75% nickel, 15% iron, the balance being copper and molybdenum. This alloy is then heat-treated in a hydrogen furnace for at least one hour and allowed to cool. It is believed that Permalloy consisting of 80% nickel and 20% iron or Supermalloy consisting 79% nickel, 5% molybdenum and the balance iron could each be substituted to achieve the similar results obtained using Mu-metal. Any of the high magnetic permeability, low coercivity, nickel alloy materials which have been heat treated in a hydrogen furnace are believed to be acceptable alternatives.

The assembled Transmitter 5 is then placed in a storage container with the electronics 220 positioned adjacent a magnet installed in the storage container (not shown in this view) which turns the Transmitter 5 to the OFF state thereby preserving the battery life of the battery 10.

Because of the encapsulation of the entirety of the sealed Transmitter 5 in epoxy, this disposable version of the Transmitter 5 is capable of immersion in most pipeline products up to 20,000 PSI. Pipeline products include, but are not limited to: crude oil, refined petroleum products such as diesel, gasoline, jet fuel, etc., natural gas, natural gas liquids, hydrogen, ethylene, propylene, butadiene, ammonia, benzene, xylene, cyclohexane, polypropylene.

As shown in FIG. 3, a reusable Transmitter 6 with replaceable battery 10, is fabricated in a similar fashion, but is sealed using a stainless steel end cap with spring contact 330 attached within a stainless steel threaded end cap 340. Cap head screws 345 hold the stainless steel end cap 330 in the stainless cap adapter. Immersion capability under pressure is achieved using sealing member 346 which can include, but is not limited to, in any combination or by themselves: o-rings, seals, gaskets, or back-up disks made of materials including but not limited to Viton, neoprene, EPDM, or Teflon.

What is claimed is:

1. A pipeline transmitter comprising:
a conductive outer protective tubular body;
an insulated interior tubular body formed from layered annealed nickel alloy sheets rolled into a circular tube;
a coil of conductive wiring wound around the interior tubular body providing an electrical connection to an electrical circuit comprised of a battery system inserted within the interior tubular body, and a electrical conductor for energizing the circuit with an alternating current from the batteries.

2. The pipeline transmitter of claim 1 wherein the interior tubular body is formed from at least two rolled sheets of an annealed high permeability nickel alloy inserted, without lamination, concentrically in each other to form the interior tubular body.

3. The pipeline transmitter of claim 1 wherein the pipeline transmitter is hermetically sealed.

4. The pipeline transmitter of claim 2 wherein the pipeline transmitter is hermetically sealed by filing the interior of the outer protective body with an epoxy.

5. The pipeline transmitter of claim 2 wherein the epoxy is allowed to cure to engage an enclosing end cap.

6. The pipeline transmitter of claim 1 wherein the pipeline transmitter is hermetically sealed by one or more O-rings between a threaded cap connected to the outer protective tubular body and a threaded upper end of the interior tubular body.

7. The pipeline transmitter of claim 1 wherein the battery system is comprised of multiple cells connected to provide an output potential for an extended life.

8. The pipeline transmitter of claim 7 wherein the battery system is connected in parallel.

9. The pipeline transmitter of claim 7 wherein the battery system is connected serially.

10. The electrical circuit of claim 1 wherein the circuit creates an on-off square wave signal to energize the coils to generate a magnetic moment from each side of the magnetic coil.

11. A pipeline transmitter comprising:
a sealed tubular conductive body;
an electrically conductive coil helically wound around a tubular body fabricated from an annealed nickel alloy providing a high magnetic permeability;
a battery power supply inserted in the annealed nickel alloy tubular body; and, a circuit connected between the battery power supply and the electrically conductive coil providing switched polarity current to the electrically conductive coil.

12. The pipeline transmitter of claim 11 wherein the sealed tubular conductive body is fabricated from aluminum.

13. The pipeline transmitter of claim 11 wherein the annealed nickel alloy consists essentially of 77% nickel, 16% iron, 5% copper, and 2% chromium.

14. The pipeline transmitter of claim 11 wherein the annealed nickel alloy consists essentially of 79% nickel, 16% iron, and 5% molybdenum.

15. The pipeline transmitter of claim 11 wherein the annealed nickel alloy consists essentially of 65% nickel, 31% iron, and 4% germanium.

16. A method for fabricating a pipeline transmitter comprising the steps of:
rolling at least two high-permeability nickel alloy sheets which have been annealed in hydrogen furnace to form a longitudinal tube;
inserting a first rolled alloy sheet forming a longitudinal tube into a second rolled alloy sheet forming a longitudinal tube;
wrapping magnet wire around the tube formed from the first and second rolled alloy sheets forming a coil;
inserting a battery and electronics within the tube formed from the first and second rolled alloy sheets;
inserting the coil, battery, and electronics into an aluminum tube providing end caps; and
filling the aluminum tube containing the coil, battery, and electronics with epoxy and placing the end caps over the epoxy to seal the transmitter within the aluminum tube.
